(19) United States
(12) Patent Application Publication
(10) Pub. No.: US 2022/0299763 A1
(43) Pub. Date: Sep. 22, 2022

(54) DISPLAY SYSTEM AND DISPLAY DEVICE

(71) Applicant: SEIKO EPSON CORPORATION, Tokyo (JP)

(72) Inventor: Shinichi KOBAYASHI, CHINO-SHI (JP)

(73) Assignee: SEIKO EPSON CORPORATION, Tokyo (JP)

(21) Appl. No.: 17/696,867

(22) Filed: Mar. 17, 2022

(30) Foreign Application Priority Data
Mar. 19, 2021 (JP) 2021-045653

(51) Int. Cl. G02B 27/01; G06F 1/3234; G06F 1/3287; G06F 3/16

(52) U.S. Cl. CPC G02B 27/017; G06F 1/3265; G06F 1/3287; G06F 3/165; G02B 2027/0178

(57) ABSTRACT

A display system including an HMD and a control device is provided. The control device includes a battery and a CO control unit configured to supply power to the HMD. The HMD includes an image display unit configured to display an image included in a playback signal received from the control device, a sound processing unit configured to output a sound included in the playback signal, a right earphone and a left earphone, a detection unit including a plurality of sensors, and a power control unit configured to supply power supplied from the control device to a supply destination. The operation of the image display unit, the sound output unit, and the plurality of sensors is stopped when the power consumed by the HMD is greater than the power supplied by the control device.

The present application is based on, and claims priority from JP Application Serial Number 2021-045653, filed Mar. 19, 2021, the disclosure of which is hereby incorporated by reference herein in its entirety.

### BACKGROUND

### 1. Technical Field

The present disclosure relates to a display system, a display device, and a control method for the display device.

### 2. Related Art

A system for coupling an information processing device and a display device, and supplying power from the information processing device the display device is known.

For example, a display system of JP-A-2002-41188 includes a small display device storing monitor request voltage information and monitor consumption current information as EDID information, and a host device configured to acquire the EDID information from the small display device. The host device controls an output voltage of the host device based on the monitor request voltage information and the monitor consumption current information acquired as the EDID information from the small display device, and a power supply voltage value and a power consumption current value detected by a detection means.

However, when the power supplied from the small display device from the host device is insufficient, the small display device cannot be used, so that only a host device capable of supplying the power to which the small display device can operate could be selected.

### SUMMARY

An aspect for solving the above-described problems is a display system including an information processing device that includes: a supply unit that supplies first power; and an output unit that outputs a playback signal including an image and a sound; and a display device that includes: a display unit that displays the image; a sound output unit that outputs the sound; a first sensor; and a supply unit that supplies the first power to the display unit, the sound output unit, and the first sensor, wherein when second power consumed by the display device is greater than the first power, part of operation of the display unit, the sound output unit, and the detection unit is stopped or the display unit, the sound output unit, and the detection unit are operated so that the second power is smaller than the first power.

An aspect for solving the above-described problems is a display system including an information processing device that includes: a supply unit that supplies first power; and an output unit that outputs a playback signal including an image; and a display device that includes: a first display unit that displays the image; a second display unit that display the image and that is different from the first display unit; and a supply unit that supplies the first power to the first display unit and the second display unit, wherein when being greater than the first power, at least one of the first display unit and the second display unit does not display the image.

An aspect for solving the above-described problems is a sensor; a display unit that displays an image; a sound output unit that outputs a sound; a supply unit that supplies first power to the display unit, the sound output unit, and the sensor; and a control unit that controls the supply unit so that second power consumed by the display unit, the sound output unit, and the sensor is less than or equal to the first power.

An aspect for solving the above-described problems is a display device including a first display unit configured to display an image, a second display unit different from the first display unit and configured to display the image, a supply unit configured to supply first power to the first display unit and the second display unit, and a control unit configured to control the first display unit and the second display unit, wherein when the second power consumed by the first display unit and the second display unit is greater than the first power, the control unit does not display the image on at least one of the first display unit and the second display unit.

An aspect for solving the above-described problems is a control method for a display device including a sensor, a display unit configured to display images, and a sound output unit configured to output a sound, the method including supplying first power to the sensor, the display unit, and the sound output unit, and controlling the first power supplied to the display unit, the sound output unit, and the detection unit so that second power consumed by the display device is less than or equal to the first power.

An aspect for solving the above-described problems is a control method for a display device including a first display unit and a second display unit, the method including supplying first power to the first display unit and the second display unit, and not displaying an image on at least one of the first display unit and the second display unit when second power consumed by the first display unit and the second display unit is greater than the first power.

### BRIEF DESCRIPTION OF THE DRAWINGS

FIG. 1 is a diagram illustrating a schematic configuration of a display system.

FIG. 2 is a plan view of a main part illustrating a configuration of an optical system of an image display unit.

FIG. 3 is a block diagram of the display system.

FIG. 4 is a block diagram of a control device.

FIG. 5 is a diagram illustrating an example of a power consumption table.

FIG. 6 is a flowchart illustrating operation of an HMD.

FIG. 7 is a flowchart illustrating operation of the control device.

FIG. 8 is a flowchart illustrating operation of the HMD.

FIG. 9 is a flowchart illustrating operation of the control device.

### DESCRIPTION OF EXEMPLARY EMBODIMENTS

1. Display System Configuration

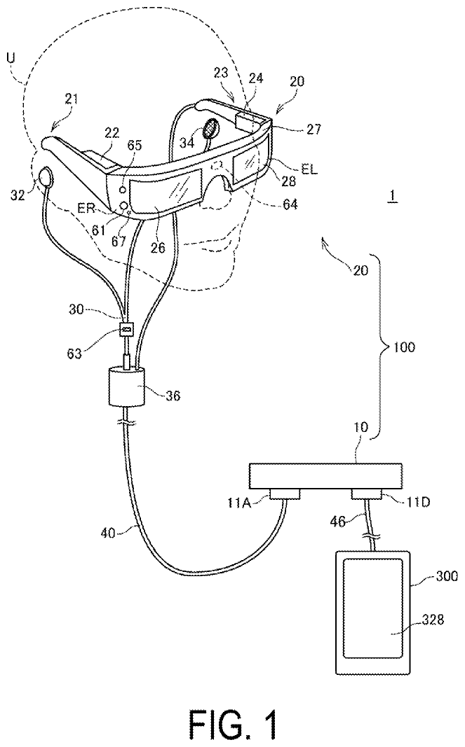

FIG. 1 is a diagram illustrating a schematic configuration of a display system 1.

The display system 1 includes an HMD 100 corresponding to a display device and a control device 300 corresponding to an information processing device. The HMD 100 is a head-mounted display apparatus including an image display unit 20 mounted on a head of a user U to allow the user to view an image and a video. The HMD is an abbreviation for Head Mounted Display.

The HMD 100 includes a coupling device 10 coupled to the image display unit 20. The coupling device 10 functions as an interface for coupling the HMD 100 to a device different from the HMD 100. In the display system 1, the control device 300 is coupled to the coupling device 10.

In the following description and drawings, for the sake of convenience of description, the name of some function units constituting the HMD 100 is denoted by the prefix DP, and the name of some function units constituting the control device 300 is denoted by the prefix CO.

The control device 300 includes a display screen that displays characters and images, and a touch panel 328 that functions as an operation unit for detecting touch operation and pressing operation, and is a portable size terminal device, and can use, for example, a smart phone. The control device 300 may be a desktop personal computer, a notebook personal computer, a tablet personal computer, etc.

The coupling device 10 includes a connector 11a and a connector 11d in a box shaped case. The image display unit 20 is coupled to the connector 11a via a coupling cable 40, and the control device 300 is coupled to the connector 11d via a USB cable 46. As a result, the image display unit 20 and the control device 300 are coupled to each other so that data can be transmitted and received. For example, the control device 300 outputs video data for the image display unit 20 to display video, and outputs the sound data to the image display unit 20. For example, the image display unit 20 transmits detection data for various sensors included in the image display unit 20 to the control device 300. The control device 300 may be capable of supplying power to the image display unit 20. The USB is an abbreviation for Universal Serial Bus.

The configuration of coupling the coupling device 10 and the control device 300 using the USB cable 46 is merely an example, and the specific coupling form of the coupling device 10 and the control device 300 is not limited. For example, other types of cables may be used to couple over a wire or via wireless communication. For example, in a configuration in which the USB cable 46 is coupled to the connector 11d of a USB-Type C standard, 20 volts DC current can be supplied by the USB cable 46, and HDMI standard video data, etc. can be transmitted as a function of the alternative mode of a USB-Type C. HDMI is a registered trademark.

The image display unit 20 includes a main body including a right holding part 21, a left holding part 23, and a front frame 27. The main body further includes a right display unit 22, a left display unit 24, a right light-guiding plate 26, and a left light-guiding plate 28.

The right holding part 21 and the left holding part 23 extend rearward from corresponding ends of the front frame 27, to hold the image display unit 20 on the head of the user U. The right holding part 21 is coupled to an end ER located on the right side of the user U in the front frame 27, and the left holding part 23 is coupled to an end EL located on the left side of the user U.

The right light-guiding plate 26 and the left light-guiding plate 28 are provided at the front frame 27. The right light-guiding plate 26 is located in front of the right eye of the user in a state where the user wears the image display unit 20, and causes the user to visually recognize an image with the right eye. The left light-guiding plate 28 is located in front of the left eye of the user in a state where the user wears the image display unit 20, and causes the user to visually recognize an image with the left eye. The right light-guiding plate 26 and the left light-guiding plate 28 are optical parts formed of a light transmissive resin, etc., and are configured to guide imaging light output by the right display unit 22 and the left display unit 24 to the eyes of the user. The right light-guiding plate 26 and the left light-guiding plate 28 are, for example, prisms.

The front frame 27 has a shape formed by coupling an end of the right light-guiding plate 26 and an end of the left light-guiding plate 28 to each other, and this coupling position corresponds to a position between eyebrows of the user in a state where the user wears the image display unit 20. The front frame 27 may include a nose pad portion abutting the nose of the user U in the wearing state of the image display unit 20, and may be configured to couple a belt to the right holding part 21 and the left holding part 23 to hold the image display unit 20 to the head of the user U by the belt.

Each of the right display unit 22 and the left display unit 24 is a module obtained by unitizing an optical unit and a peripheral circuit. The right display unit 22 displays an image by the right light-guiding plate 26, and the left display unit 24 displays an image by the left light-guiding plate 28. The right display unit 22 is provided at the right holding part 21 and the left display unit 24 is provided at the left holding part 23.

The imaging light guided by the right light-guiding plate 26 and the outside light transmitted through the right light-guiding plate 26 are incident on the right eye of the user U. Similarly, the imaging light guided by the left light-guiding plate 28 and the outside light transmitted through the left light-guiding plate 28 are incident on the left eye. The imaging light from the right light-guiding plate 26 and the left light-guiding plate 28 and the outside light transmitted through the right light-guiding plate 26 and the left light-guiding plate 28 are incident on the eye of the user U. As a result, the user U views the image displayed by the image display unit 20 overlaid on the image transmitted through the right light-guiding plate 26 and the left light-guiding plate 28.

A DP illuminance sensor 65 is arranged at the front frame 27. The DP illuminance sensor 65 is a sensor that receives outside light coming from the front of the user U who wears the image display unit 20. The DP illuminance sensor 65 can detect the illumination and the amount of the outside light incident on the eye of the user U by transmitting through the right light-guiding plate 26 and the left light-guiding plate 28.

A DP outer camera 61 is provided at the front frame 27 and positioned so that the DP outer camera 61 does not block the outside light transmitted through the right light-guiding plate 26 and the left light-guiding plate 28. The DP outer camera 61 is a digital camera including an image capturing element, an image capturing lens, etc., and may be a monocular camera or a stereo camera. The angle of view of the DP outer camera 61 includes at least a portion of the range of the outside scene that the user U wearing the image display unit 20 sees through the right light-guiding plate 26 and the left light-guiding plate 28. The DP outer camera 61 may be a wide angle camera and may be capable of capturing the entire outside scene viewed by the user U wearing the image display unit 20. CCD is an abbreviation for Charge Coupled Device, and CMOS is an abbreviation for Complementary Metal Oxide Sensor.

An LED indicator 67 that lights up during the operation of the DP outer camera 61 is arranged at the front frame 27.

The front frame 27 is provided with a distance sensor 64 that detects a distance to a target object located in a preset measurement direction. The distance sensor 64 is, for example, a light reflective distance sensor using an LED, a laser diode, etc., an infrared depth sensor, an ultrasonic distance sensor, or a laser range scanner. The distance sensor 64 may be a distance detection unit that combines image detection and sound detection, or a device that processes an image obtained by stereo imaging by a camera to detect a distance. The measurement direction of the distance sensor 64 is, for example, the direction of the outside scene viewed by the user U through the right light-guiding plate 26 and the left light-guiding plate 28.

The right display unit 22 and the left display unit 24 are each coupled to the coupling device 10 by the coupling cable 40. The coupling cable 40 includes an audio connector 36. A headset 30 having a right earphone 32 and a left earphone 34 constituting a stereo headphone and a microphone 63 are coupled to the audio connector 36. The right earphone 32 and the left earphone 34 output a sound based on a sound signal output from the coupling device 10. The microphone 63 is configured to collect a sound and outputs the sound signal to the coupling device 10.

2. Configuration of the Optical System of the Image Display Unit

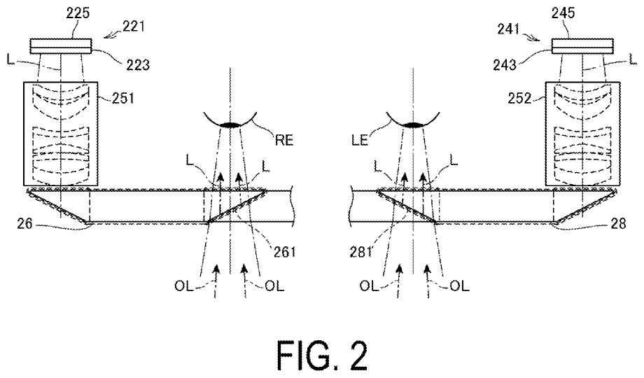

FIG. 2 is a plan view of a main part illustrating a configuration of an optical system of an image display unit 20. In FIG. 2, a left eye LE and a right eye RE of a user are illustrated for explanation.

The right display unit 22 and the left display unit 24 are configured to be left-right symmetrical, for example.

As a configuration to make the image visible to the right eye RE, the right display unit 22 includes an OLED unit 221 that emits imaging light and a right optical system 251 that guides the imaging light L emitted by the OLED unit 221 to the right light-guiding plate 26. OLED is an abbreviation for Organic Light Emitting Diode.

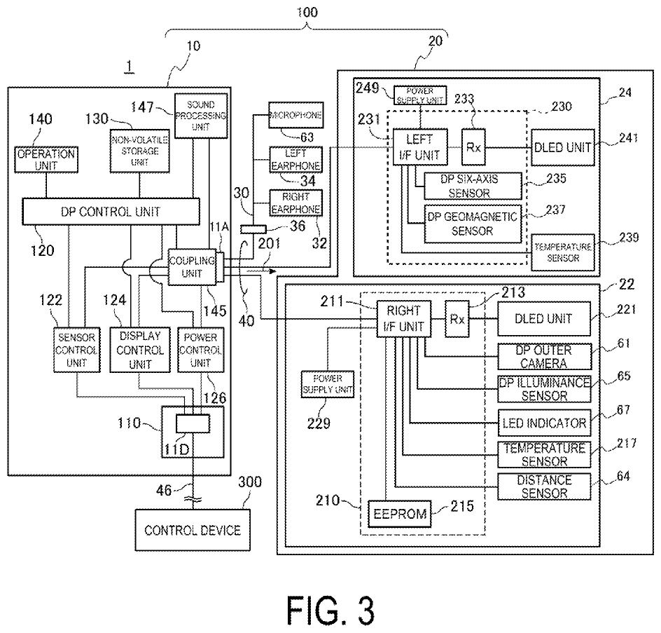

The OLED unit 221 includes an OLED panel 223 and an OLED drive circuit 225 configured to drive the OLED panel 223. The OLED panel 223 is a self-luminous display panel in which, for example, a light emitting element that emit colored light of R, G, and B is disposed. The OLED drive circuit 225 drives the OLED panel 223 in accordance with the control of a DP control unit 120. The OLED drive circuit 225 is mounted on a substrate (not illustrated) secured to the back surface of the OLED panel 223, for example, and a temperature sensor 217 illustrated in FIG. 3 is mounted on the substrate.

The right optical system 251 converts the imaging light L emitted from the OLED panel 223 into a light flux in a parallel state by a collimating lens, and causes the imaging light L to be incident on the right light-guiding plate 26. The imaging light L is reflected by a plurality of reflection surfaces within the right light-guiding plate 26, and is reflected by a half mirror 261 located in front of the right eye RE, and emitted from the right light-guiding plate 26 toward the right eye RE.

As a configuration to make the image visible to the left eye LE, the right display unit 22 includes an OLED unit 241 that emits imaging light and a left optical system 252 that guides the imaging light L emitted by the OLED unit 241 to the left light-guiding plate 28.

The OLED unit 241 includes an OLED panel 243, and an OLED drive circuit 245 configured to drive the OLED panel 243. The OLED panel 243 is a self-luminous display panel in which, for example, a light emitting element that emit colored light of R, G, and B is disposed. The OLED drive circuit 245 drives the OLED panel 243 in accordance with the control of the DP control unit 120. The OLED drive circuit 245 is mounted on a substrate (not illustrated) secured to the back surface of the OLED panel 243, for example, and a temperature sensor 239 illustrated in FIG. 3 is mounted on the substrate.

The left optical system 252 converts the imaging light L emitted from the OLED panel 243 into a light flux in a parallel state by a collimating lens, and causes the imaging light L to be incident on the left light-guiding plate 28. The imaging light L is reflected by the plurality of reflection surfaces within the left light-guiding plate 28, and is reflected by the half mirror 261 located in front of the eye of the left eye LE and emitted from the left light-guiding plate 28 toward the left eye LE.

The HMD 100 functions as a transmissive display device. Namely, the imaging light L reflected by the half mirror 261 and outside light OL having transmitted through the right light-guiding plate 26 enter the right eye RE of the user. Additionally, the imaging light L reflected by the half mirror 281 and the outside light OL having transmitted through the half mirror 281 enter the left eye LE. The HMD 100 superimposes the imaging light L of the internally processed image and the outside light OL and causes them to be incident on the eye of the user U. This allows the user U to see the outside view through the right light-guiding plate 26 and the left light-guiding plate 28, and the image by the imaging light L is visually recognized by superimposing the outside view. The half mirrors 261, 281 are image extraction units that reflect the imaging light output by the right display unit 22 and the left display unit 24 to extract an image, and constitute a display unit.

3. HMD Control System

FIG. 3 is a block diagram of the display system 1, and in particular, illustrating the configuration of the HMD 100 in detail.

In the image display unit 20, the right display unit 22 has a right display unit substrate 210. At the right display unit substrate 210, a right I/F unit 211 coupled to the coupling cable 40, a receiving unit 213 that receives data input from the coupling device 10 via the right I/F unit 211, and an EEPROM 215 are mounted. The right I/F unit 211 couples the receiving unit 213, the EEPROM 215, the temperature sensor 217, the DP outer camera 61, the distance sensor 64, the DP illuminance sensor 65, and the LED indicator 67 to the coupling device 10. The receiving unit 213 couples the OLED unit 221 to the coupling device 10.

The left display unit 24 includes a left display unit substrate 230. At the left display unit substrate 230, a left I/F unit 231 coupled to the coupling cable 40, a receiving unit 233 that receives data input from the coupling device 10 via the left I/F unit 231 are mounted. A DP six-axis sensor 235 and a DP magnetic sensor 237 are mounted on the left display unit substrate 230.

The left I/F unit 231 couples the receiving unit 233, the DP six-axis sensor 235, the DP magnetic sensor 237, and the temperature sensor 239 to the coupling device 10. The receiving unit 233 couples the OLED unit 241 to the coupling device 10.

The EEPROM is an abbreviation for Electrically Erasable Programmable Read-Only Memory. Also, each of the receiving unit 213 and receiving unit 233 may be described as Rx213, Rx233.

The EEPROM 215 is configured to store various types of data in a non-volatile manner. The EEPROM 215 stores, for example, data about light-emitting properties and display properties of the OLED units 221, 241 provided at the image display unit 20, and data about a property of a sensor provided at the right display unit 22 or the left display unit 24. Specifically, the DP control unit 120 readably stores parameters related to gamma correction of the OLED units 221, 241 and data for compensating for the detection values of the temperature sensors 217, 239.

The DP outer camera 61 performs imaging in accordance with a signal input via the right I/F unit 211, and outputs captured image data to the right I/F unit 211. The DP illuminance sensor 65 is configured to receive the outside light and output a detection value corresponding to an amount of the received light or an intensity of the received light. The LED indicator 67 is configured to light up in accordance with a control signal or a driving current input via the right I/F unit 211.

The temperature sensor 217 is configured to detect a temperature of the OLED unit 221, and outputs a voltage value or a resistance value corresponding to the detected temperature as a detection value.

The distance sensor 64 outputs a signal indicating the detection result of detecting the distance to the coupling device 10 via the right I/F unit 211.

The receiving unit 213 receives the video data for display transmitted from the coupling device 10 via the right I/F unit 211, and outputs the video data for display to the OLED unit 221. The OLED unit 221 displays an image based on the image data transmitted by the coupling device 10.

The receiving unit 233 receives the video data for display transmitted from the coupling device 10 via the left I/F unit 231 and outputs the video data for display to the OLED unit 241. The OLED unit 221, 241 display an image based on the image data transmitted by the coupling device 10.

The DP six-axis sensor 235 is a motion sensor including a three-axis acceleration sensor and a three-axis gyro sensor. The DP magnetic sensor 237 is a three-axis geomagnetic sensor, for example. The DP six-axis sensor 235 and the DP magnetic sensor 237 may be an IMU in which each of the above sensors is modularized, or may be a module in which the DP six-axis sensor 235 and the DP magnetic sensor 237 are integrated. The IMU is an abbreviation for Inertial Measurement Unit. The temperature sensor 239 detects the temperature of the OLED unit 241. The DP six-axis sensor 235, the DP magnetic sensor 237, and the temperature sensor 239 each output the detection value to the coupling device 10.

Each component of the image display unit 20 operates with power supplied from the coupling device 10 via the coupling cable 40. The image display unit 20 includes a power supply unit 229 on the right display unit 22, and a power supply unit 249 on the left display unit 24. The power supply unit 229 is configured to distribute and supply the power supplied by the coupling device 10 via the coupling cable 40 to each part of the right display unit 22 including the right display unit substrate 210. The power supply unit 249 is configured to distribute and supply the power supplied by the coupling device 10 via the coupling cable 40 to each part of the left display unit 24 including the left display unit substrate 230. The power supply units 229, 249 may include a conversion circuit, etc. that converts voltage. The power supply units 229, 249 correspond to the power supply unit together with a power control unit 126.

The coupling device 10 includes an I/F unit 110, a DP control unit 120, a sensor control unit 122, a display control unit 124, a power control unit 126, a non-volatile storage unit 130, an operation unit 140, a coupling unit 145, and a sound processing unit 147.

The I/F unit 110 includes a connector 11D and an interface circuit that executes a communication protocol conforming to various communication standards. The I/F unit 110 is, for example, an interface substrate on which a connector 11D and the interface circuit are mounted. The I/F unit 110, for example, may include an interface for a memory card capable of being coupled with an external storage device or storage medium, etc., or the I/F unit 110 may include a radio communication interface.

The DP control unit 120 includes a processor such as a CPU and a microcomputer, and the processor executes a program to control each unit of the coupling device 10. The DP control unit 120 may include a RAM constituting a work area of the processor. The RAM is an abbreviation for Random Access Memory.

The DP control unit 120 is coupled to the non-volatile storage unit 130, the operation unit 140, the coupling unit 145, and the sound processing unit 147. The non-volatile storage unit 130 is a ROM that stores programs and data executed by the DP control unit 120 in a non-volatile manner. The ROM is an abbreviation for Read Only Memory.

The sensor control unit 122 operates a sensor group included in the image display unit 20. The sensor group includes the DP outer camera 61, the distance sensor 64, the DP illuminance sensor 65, the temperature sensor 217, the DP six-axis sensor 235, the DP magnetic sensor 237 and the temperature sensor 239. the sensor control unit 122 is configured to perform setting and initialization of a sampling period of each sensor according to control of the DP control unit 120, and execute energization to each sensor, transmission of control data, acquisition of detection values, etc., in correspondence to the sampling period of each sensor.

The sensor control unit 122 outputs detection data indicative of the detection value and the detection result of each sensor to the I/F unit 110 at a preset timing. Here, the captured image data of the DP outer camera 61 is referred to as detection data in the same manner as the detection value and detection result of the other sensors.

The sensor control unit 122 may include an A/D converter that converts the analog signal into digital data. In this case, the sensor control unit 122 converts the detection value acquired from the sensor of the image display unit 20 and the analog signal of the detection result into detection data and outputs the detection data. The sensor control unit 122 may acquire the detection value and the digital data of the detection result from the sensor of the image display unit 20, and output the detection data to the I/F unit 110 by performing a conversion of the data format, adjustment of the output timing, etc.

By the operation of the sensor control unit 122, the control device 300 coupled to the I/F unit 110 can acquire the detection value of each sensor of the HMD 100 and the captured image data of the DP outer camera 61.

The sensor control unit 122 may output the result of arithmetic processing based on the detection value of each of the above-mentioned sensors as detection data. For example, the sensor control unit 122 may integrally process the detection value and detection result of a plurality of sensors and function as a so-called sensor fusion processing unit. In this case, the sensor control unit 122 may generate detection data for a virtual sensor not included in each sensor of the image display unit 20 by the sensor fusion. For example, the sensor control unit 122 may output, as detection data, trajectory data indicating the trajectory of movement of the image display unit 20, coordinate data indicating a position of the image display unit 20 in the three-dimensional space, and directional data indicating the direction of the image display unit 20. Here, the coordinate data may be data indicating relative coordinates with respect to the position of the coupling device 10, or may be data indicating a position with respect to a reference position set in the space in which the image display unit 20 is present. The direction data may be data indicating a direction based on a position and a direction of the coupling device 10, or may be data indicating a direction with respect to a reference position set in the space in which the image display unit 20 is present.

The sensor control unit 122 executes a communication protocol between the connector 11d and the device coupled by the USB cable 46, and outputs the detection data.

The display control unit 124 executes various kinds of processing for displaying an image on the image display unit 20 based on the video data included in the playback signal input to the I/F unit 110 or the display data. In the present exemplary embodiment, the video data is transmitted in an alternative mode of the USB-Type C through the connector 11D constituted by the USB-Type C connector. For example, the display control unit 124 is configured to execute various kinds of processing such as cutting out of a frame, resolution conversion, scaling, intermediate frame generation, and frame rate conversion, etc. The display control unit 124 outputs the video data corresponding to the OLED units 221, 241 to the coupling unit 145. The video data input to the coupling unit 145 is transmitted from the connector 11A to the right I/F unit 211 and the left I/F unit 231 as a video signal 201. The display control unit 124 adjusts and changes the display state of the image display unit 20 in accordance with the display control data input to the I/F unit 110.

At least one of the sensor control unit 122 and the display control unit 124 may be realized by the cooperation of software and hardware by executing a program by the processor. That is, the sensor control unit 122 and the display control unit 124 are configured by a processor to execute a program to execute the operations described above. In this example, the sensor control unit 122 and the display control unit 124 may be realized by a processor constituting the DP control unit 120 executing a program. In other words, the processor may function as the DP control unit 120, the display control unit 124 and the sensor control unit 122 by executing a program. Here, the processor can be paraphrased as a computer. The sensor control unit 122 and the display control unit 124 may be provided with a work memory for performing data processing, or may perform processing using the memory of the DP control unit 120.

Further, the display control unit 124 and the sensor control unit 122 may include programmed hardware such as DSP, FPGA. Further, the sensor control unit 122 and the display control unit 124 may be integrated to be configured of an SoC-FPGA. The DSP is an abbreviation for Digital Signal Processor. The FPGA is an abbreviation for Field Programmable Gate Array. The SoC is an abbreviation for System-on-a-Chip.

The power control unit 126 is a circuit coupled to the connector 11D and supplying power to each unit of the coupling device 10 and the image display unit 20 based on the power supplied from the connector 11D.

The power control unit 126 corresponds to the power supply unit together with the power supply units 229, 249.

The operation unit 140 detects operation of a switch, etc. included in the coupling device 10, and outputs data indicating the operation content to the DP control unit 120.

The sound processing unit 147 generates a sound signal according to the sound data input from the DP control unit 120. This sound data also includes sound data included in the playback signal input from the control device 300. The sound processing unit 147 includes an amplifier, and amplifies the generated sound signal and outputs the amplified sound signal to the coupling unit 145. This sound signal is output from the coupling unit 145 to the right earphone 32 and the left earphone 34 via the audio connector 36. The sound processing unit 147 generates sound data of the sound collected by the microphone 63 and outputs it to the DP control unit 120. The sound data output by the sound processing unit 147 may be processed by the sensor control unit 122 in the same manner as the detection data of the sensor included in the image display unit 20.

4. Control Device Configuration

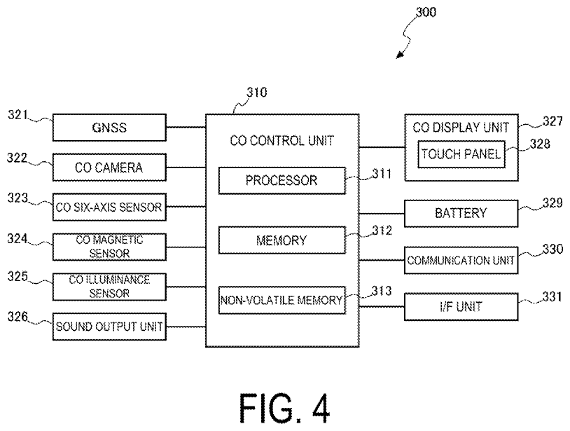

FIG. 4 is a block diagram of the control device 300.

The control device 300 includes a CO control unit 310. The CO control unit 310 includes a processor 311 and a memory 312 and a non-volatile memory 313. The processor 311 is constituted by a CPU, a microcomputer, a DSP, etc., and controls each part of the control device 300 by executing a program. The memory 312 forms a work area of the processor 311. The non-volatile memory 313 is constituted by a semiconductor memory function unit, etc., and stores various types of data to be processed by the processor 311, such as a program executed by the processor 311. For example, the non-volatile memory 313 stores an operating system as a basic control program executed by the processor 311 and an application program running on the operating system. The non-volatile memory 313 stores data processed at the time of execution of the application program and data of the processing result. The CO control unit 310 may be a SoC in which the processor 311, the memory 312, and the non-volatile memory 313 are integrated.

A GNSS 321, a CO camera 322, a CO six-axis sensor 323, a CO magnetic sensor 324, a CO illuminance sensor 325, a sound output unit 326, a CO display 327, a battery 329, a communication unit 330 and an I/F unit 331 are coupled to the CO control unit 310.

The GNSS 321 uses the satellite positioning system to perform positioning, and outputs the position of the control device 300 to the CO control unit 310. The GNSS is a notation omitting the Global Navigation Satellite System.

The CO camera 322 is a digital camera provided at a main body of the control device 300, and is arranged adjacent to the touch panel 328, for example, and images the direction facing the touch panel 328. The CO camera 322 executes imaging according to the control of the CO control unit 310, and outputs the captured image data to the CO control unit 310.

The CO six-axis sensor 323 is a motion sensor including a three-axis acceleration sensor and a three-axis gyro sensor, and outputs detection data indicating a detection value to the CO control unit 310. The CO magnetic sensor 324 is, for example, a three-axis geomagnetic sensor, and outputs detection data indicative of the detection value to the CO control unit 310. The CO six-axis sensor 323 and CO magnetic sensor 324 may be an IMU in which each of the above sensors is modularized, or may be a module in which the CO six-axis sensor 323 and the CO magnetic sensor 324 are integrated.

The CO illuminance sensor 325 receives the outside light and outputs the detection data indicating a detection value corresponding to an amount of the received light or an intensity of the received light to the CO control unit 310.

The sound output unit 326 includes a speaker, and outputs a sound from the speaker in accordance with the control of the CO control unit 310. The sound output unit 326 may include an amplifier that amplifies the sound signal output by the CO control unit 310 and outputs the amplified sound signal to a speaker. When the CO control unit 310 is configured to output digital sound data, the sound output unit 326 may include a D/A converter that converts digital sound data to an analog sound signal.

The CO display unit 327 has the touch panel 328, and displays characters and images on the touch panel 328 in accordance with the control of the CO control unit 310.

The battery 329 is a secondary battery built into the main body of the control device 300, supplies power to each part of the control device 300, and supplies power to the coupled HMD 100.

When the HMD 100 is coupled to the I/F unit 331, the CO control unit 310 negotiates with the HMD 100 to determine the power supplied to the HMD 100. The negotiation is a process for performing, for example, a power roll setting, a setting of the amount of power to be transferred, etc. The power roll is a power source that functions as a supply source to supply power or a power sink that receives power from a power source.

The CO control unit 310 supplies the power determined by the negotiation to the HMD 100 via the I/F unit 331.

The battery 329 and CO control unit 310 correspond to the first supply unit.

The communication unit 330 corresponds to a wireless communication protocol such as Bluetooth or Wi-Fi, and performs wireless communication with a device external to the display system 1. The Bluetooth and Wi-Fi are registered trademarks. The communication unit 330 may be configured to perform mobile data communication using a mobile communication network such as LTE or a fifth generation mobile communication system. The LTE is a registered trademark.

The I/F unit 331 includes a connector (not illustrated) to which a data communication cable is coupled, and an interface circuit that executes a communication protocol conforming to various communication standards by the connector. For example, the I/F unit 331 includes a connector and an interface circuit conforming to the USB standard, and transmits and receives data through the USB cable 46 and supplies power to the HMD 100.

The non-volatile memory 313 stores content data.

The CO control unit 310 plays the content data and generates a playback signal including a video and a sound. The CO control unit 310 transmits the generated playback signal to the HMD 100 via the I/F unit 331.

5. Operation when the Control Device 300 and the HMD 100 are Coupled

When the control device 300 is coupled to the coupling device 10, the DP control unit 120 performs negotiation with the control device 300, and acquires information of the power supplied to the HMD 100 by the control device 300.

When the HMD 100 is not equipped with a battery, the control device 300 supplies the HMD 100 with the power required for the control device 300 to execute the negotiation when coupled to the HMD 100. The control device 300 supplies the necessary power for the HMD 100 operation when the negotiation with the HMD 100 ends.

When the DP control unit 120 acquires the information of the power supplied from the control device 300, the DP control unit 120 compares the power indicated by the acquired information to the power consumed by the HMD 100.

When the power consumed by the HMD 100 is greater than the power that can be supplied by the control device 300, the DP control unit 120 stops the operation of at least part of the image display unit 20, the sound output unit, and the sensor group. Further, when the power consumed by the HMD 100 is greater than the power that can be supplied by the control device 300, the DP control unit 120 switches the HMD 100 to a low power consumption setting.

The image display unit 20 includes the right display unit 22 and the left display unit 24.

The sound output unit includes the sound processing unit 147, the right earphone 32, and the left earphone 34.

The sensor group is a detection unit mounted on the HMD 100 and includes the DP outer camera 61, the distance sensor 64, the DP illuminance sensor 65, the temperature sensor 217, the DP six-axis sensor 235, the DP magnetic sensor 237 and the temperature sensor 239. Each sensor constituting the image display unit 20, the sound output unit, and the sensor group is referred to as a “function unit”.

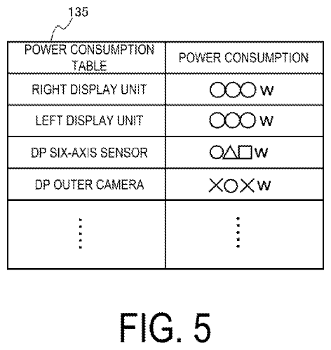

FIG. 5 is a diagram illustrating an example of a power consumption table 135.

The non-volatile storage unit 130 stores the power consumption table 135 illustrated in FIG. 5.

The power consumption table 135 is a table in which identification information identifying the function units and the power consumption of each function unit are registered in association with each other.

First, a case in which the DP control unit 120 stops operating at least part of the image display unit 20, the sound output unit, and the sensor group will be described.

When the power consumed by the HMD 100 is greater than the power that can be supplied by the control device 300, the DP control unit 120 refers to the power consumption table 135 to select the most power consuming function unit. The DP control unit 120 determines, by not operating the selected function unit, whether the power consumed by the HMD 100 is less than or equal to the power that can be supplied by the control device 300.

When the power consumed by the HMD 100 is less than or equal to the power that can be supplied by the control device 300, the DP control unit 120 controls the power control unit 126 so that power is not supplied to the selected function unit, and sets the selected function unit to not operate.

In addition, even when the DP control unit 120 is set to not operate the most power consuming function unit, in a case where the power consumed by the HMD 100 is not less than or equal to the power that can be supplied by the control device 300, the DP control unit 120 refers to the power consumption table 135 to select a function unit that does not operate. The DP control unit 120 refers to the power consumption table 135 to select the function unit having the second highest power consumption. When the function units having the first and second highest power consumption are selected, the DP control unit 120 determines, by not operating these selected function units, whether the power consumed by the HMD 100 is less than or equal to the power that can be supplied by the control device 300. When the power consumed by the HMD 100 is less than or equal to the power that can be supplied by the control device 300, the DP control unit 120 controls the power control unit 126 so that power is not supplied to the selected function unit, and sets the selected function unit to not operate.

When the power consumed by the HMD 100 is not less than or equal to the power that can be supplied by the control device 300, the DP control unit 120 selects the function unit having the third highest power consumption. The DP control unit 120 repeats the same process until the power consumed by the HMD 100 is less than or equal to the power that can be supplied by the control device 300.

The DP control unit 120 may calculate a difference between the power consumed by the HMD 100 and the power that can be supplied by the control device 300, and may select a function unit that does not operate based on the calculated difference. The DP control unit 120 refers to the power consumption table 135 to select a function unit or combination of the function units that consumes more power than the calculated difference, controls the power control unit 126 so that power is not supplied to the selected function unit, and sets the selected function unit to not operate.

In a case where a priority is set to the function unit, the DP control unit 120 may select a function unit to stop operation in accordance with this priority. For example, it is assumed that the priority of the right display unit 22 of the image display unit 20 is set to be the highest, and hereinafter, the priorities are set in order of the DP outer camera 61, the sound output unit, and the sensor group. In this case, the DP control unit 120 selects the function unit having the highest priority in accordance with the set priority. The DP control unit 120 subtracts the power consumed by the selected function unit from the power consumed by the HMD 100. When the subtracted power is less than or equal to the power that can be supplied by the control device 300, the DP control unit 120 controls the power control unit 126 so that the power is not supplied to the function unit having the highest priority, and sets the selected function unit to not operate. In the present exemplary embodiment, a case in which a priority setting is prioritized to stop operation is described, however, a priority setting may set the priority of the function unit for which the operation is not desired to be stopped. In this case, the DP control unit 120 selects a function unit that stops operation in order of low priority. In addition, the priority setting may be a priority of a function unit that changes operating parameters rather than a priority of a function unit that stops operation.

In addition, when the power obtained by subtracting the power consumption of the function unit selected from the power consumed by the HMD 100 is greater than the power that can supplied by the control device 300, the DP control unit 120 the function unit having the second highest priority. The DP control unit 120 subtracts the power consumption of the function units having the first and second highest priority selected from the power consumed by the HMD 100. When the subtracted power consumption is less than or equal to the power that can be supplied by the control device 300, the DP control unit 120 controls the power control unit 126 so that the power is not supplied to the function units having the first and second highest priority, and sets the selected function unit to not operate. The DP control unit 120 repeats the same process until the power consumed by the HMD 100 is less than or equal to the power that can be supplied by the control device 300.

Also, the DP control unit 120 may not stop the operation of the HMD 100 function unit necessary to execute an application program in a case where the application program installed on the control device 300 is activated. Hereinafter, the application program is simply referred to as an app.

For example, it is assumed that the music player app is activated at the control device 300 and a sound is output from the right earphone 32 and the left earphone 34 of the HMD 100. In this case, the DP control unit 120 sets that the operation of the sound output unit is not stopped even when the power consumed by the sound output unit is high and the priority is set high. It is also assumed that a map app of the control device 300 is activated. In this case, the DP control unit 120 may not stop the operation of the DP six-axis sensor 235 included in the sensor group even when the power consumption of the DP six-axis sensor 235 is high and the priority is set high.

Next, a case in which the DP control unit 120 switches the HMD 100 to a low power consumption setting so that the control device 300 does not exceed the power that can be supplied by the control device 300 when the power consumed by the HMD 100 is greater than the power that can be supplied by the control device 300 will be described.

For example, the DP control unit 120 may cause the display control unit 124 to change at least one of a refresh rate of the image displayed on the right display unit 22 and the left display unit 24 and image brightness, based on the power consumed by the HMD 100 and the power that can be supplied by the control device 300. The DP control unit 120 changes at least one of the refresh rate and the image brightness based on a preset threshold value. For example, the DP control unit 120 determines the difference between the power that can be supplied by the control device 300 and the power consumed by the HMD 100, and compares the determined power difference to the threshold value. When the determined power difference is less than or equal to a first threshold, the DP control unit 120 instructs the display control unit 124 to change at least one of the refresh rate of the image displayed in the right display unit 22 and the left display unit 24 and the image brightness. When the determined power difference is less than or equal to a second threshold, the DP control unit 120 instructs the display control unit 124 to change the refresh rate of the image displayed in the right display unit 22 and the left display unit 24 and the image brightness. The second threshold is set to a value greater than the first threshold.

In accordance with the control of the DP control unit 120, the display control unit 124 controls the right display unit 22 and the left display unit 24 such that the refresh rate of the image displayed in the right display unit 22 and the left display unit 24 is reduced as compared with a case where the control device 300 is capable of supplying the power consumed by the HMD 100.

Further, in accordance with the control of the DP control unit 120, the display control unit 124 controls the right display unit 22 and the left display unit 24 such that the brightness of the image displayed in the right display unit 22 and the left display unit 24 is reduced as compared with a case where the control device 300 is capable of supplying the power consumed by the HMD 100.

The DP control unit 120 may reduce the refresh rate of either the right display unit 22 or the left display unit 24 and reduce the brightness. The DP control unit 120 may set to cause the image to not be displayed on either the right display unit 22 or the left display unit 24. The DP control unit 120 may set the right display unit 22 and the left display unit 24 to reduce the refresh rate, reduce the brightness, and cause the image to not be displayed on the other of the right display unit 22 and the left display unit 24.

The DP control unit 120 may also instruct the sensor control unit 122 to reduce the sampling frequency of at least some sensors included in the sensor group as compared with a case where the control device 300 is capable of supplying the power consumed by the HMD 100. For example, the DP control unit 120 instructs the sensor control unit 122 of a sensor that sets the sampling frequency low based on the difference between the power that can be supplied by the control device 300 and the power consumed by the HMD 100 and the preset priority. The sensor control unit 122 controls the right display unit 22 and the left display unit 24 such that the sampling frequency of the sensor designated by the DP control unit 120 is reduced as compared with a case where the control device 300 is capable of supplying the power consumed by the HMD 100.

The DP control unit 120 may cause the sensor control unit 122 to change at least one of an imaging resolution of the DP outer camera 61 and a number of times of imaging per unit time based on the power consumed by the HMD 100 and the power that can be supplied by the control device 300. The DP control unit 120 causes the sensor control unit 122 to change at least one of an imaging resolution of the DP outer camera 61 and the number of times of imaging per unit time based on the preset threshold.

The DP control unit 120 instructs the sensor control unit 122 to change at least one of the imaging resolution of the DP outer camera 61 and the number of times of imaging per unit time when the difference between the power that can be supplied by the control device 300 and the power consumed by the HMD 100 is less than or equal to the threshold.

Further, the DP control unit 120 instructs the sensor control unit 122 to change the imaging resolution of the DP outer camera 61 and the number of times of imaging per unit time when the difference between the power that can be supplied by the control device 300 and the power consumed by the HMD 100 is greater than or equal to a preset threshold.

In accordance with the control of the DP control unit 120, the sensor control unit 122 controls the DP outer camera 61 so that the imaging resolution of the DP outer camera 61 is reduced as compared with a case where the control device 300 is capable of supplying the power consumed by the HMD 100.

Further, in accordance with the control of the DP control unit 120, the sensor control unit 122 also controls the DP outer camera 61 so that the number of times of imaging per unit time of the DP outer camera 61 is reduced as compared with a case where the control device 300 is capable of supplying the power consumed by the HMD 100.

The DP control unit 120 may also reduce the sound output to the sound output unit based on the power consumed by the HMD 100 and the power that can be supplied by the control device 300.

The DP control unit 120 may calculate the difference between the power that can be supplied by the control device 300 and the power consumed by the HMD 100, and compare the calculated difference to a preset threshold value to determine the sound pressure of the sound to be output to the sound output unit. Since the power consumed by the amplifier is high, the power consumed by the HMD 100 can be reduced by reducing the sound pressure of the sound output from the sound output unit. Additionally, when the difference between the calculated power that can be supplied by the control device 300 and the power consumed by the HMD 100 is greater than or equal to the preset threshold, the DP control unit 120 may stop outputting sound to the sound output unit.

In addition, the operating mode of HMD 100 may be preset, and an operating mode may be determined in which the HMD 100 is operated based on the difference between the power consumed by the HMD 100 and the power that can be supplied by the control device 300.

For example, as an operating mode, the HMD 100 includes three operating modes: a first operating mode, a second operating mode, and a third operating mode.

The DP control unit 120 changes the operating mode to either of the first operating mode, the second operating mode, and the third operating mode in accordance with the power supplied from the control device 300.

The first operating mode is a mode in which all of the right display unit 22 and the left display unit 24 of the image display unit 20, the DP outer camera 61, the sound processing unit 147, the right earphone 32 and the left earphone 34, and the sensor groups are operable.

The second operating mode is a mode in which the power consumption is reduced as compared with the first operating mode.

When the second operating mode is selected, the DP control unit 120 only operates one of the right display unit 22 and the left display unit 24. Also, when the second operating mode is selected, the DP control unit 120 controls the sensor control unit 122 to reduce the imaging frame rate of the DP outer camera 61 as compared with a case of the first operating mode. The DP control unit 120 controls the sensor control unit 122 to reduce the sampling frequency of the sensor group as compared with a case of the first operating mode.

The third operating mode is a mode with lower power consumption than the second operating mode.

The DP control unit 120 stops the operation of either of the DP outer camera 61 and the sensor group when the third operating mode is selected.

When the third operating mode is selected, the DP control unit 120 reduces at least one of the refresh rate and brightness of the right display unit 22 and the left display unit 24 as compared with a case of the first operating mode.

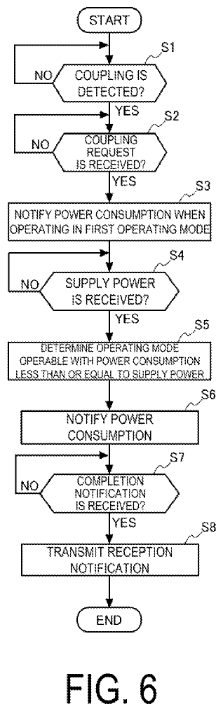

FIG. 6 is a flowchart illustrating operation of the HMD 100 in the negotiation.

The DP control unit 120 detects the coupling of the control device 300 to the I/F unit 110 (step S1). The DP control unit 120 detects the coupling to the I/F unit 110 in a case where, for example, the VBUS is detected by a voltage monitoring unit (not illustrated) provided at the I/F unit 110. When the coupling is not detected (step S1/NO), the DP control unit 120 does not transition to step S3 and subsequent steps.

When the coupling is detected (step S1/YES), the DP control unit 120 determines whether a coupling request has been received from the coupled control device 300 (step S2). When the DP control unit 120 has not received the coupling request (step S2/NO), the DP control unit 120 does not transition to step S3 and subsequent steps.

When the DP control unit 120 receives the coupling request from the control device 300 (step S2/YES), the DP control unit 120 notifies the control device 300 of the power consumption when the HMD 100 is operated in the first operating mode that does not limit the power consumed by the HMD 100 (step S3).

Next, the DP control unit 120 determines whether the control device 300 has received a notification of the supply power, which is the power that can be supplied to the HMD 100 (step S4).

When the DP control unit 120 has not received the notification of the supply power from the control device 300 (step S4/NO), the DP control unit 120 does not transition to step S5 and subsequent steps.

When the DP control unit 120 receives a notification of the supply power from the control device 300 (step S4/YES), the DP control unit 120 determines an operating mode in which the power consumed by the HMD 100 is less than or equal to the supplied power notified (step S5). When there are a plurality of operating modes in which the power consumption is less than or equal to the supplied power notified, the DP control unit 120 selects an operating mode in which the power consumption is highest, and less than or equal to the supply power notified by the control device 300. In addition, the DP control unit 120 may set the priorities for each operating mode, and select an operating mode with the highest priority among operating modes in which the power consumption is less than or equal to the supplied power notified. In addition, when there is an operating mode selected at the time of the previous coupling with the control device 300 among the operating modes in which the power consumption is less than or equal to the supplied power notified, the DP control unit 120 may select the operating mode selected at the time of this previous coupling.

When the DP control unit 120 determines the operating mode in which the power consumption is less than or equal to the supplied power notified, the DP control unit 120 notifies the control device 300 of the power consumption of the determined operating mode (step S6).

Next, the DP control unit 120 determines whether the control device 300 has received a completion notification of the negotiation (step S7). When the DP control unit 120 has not received the completion notification from the control device 300 (step S7/NO), the DP control unit 120 does not transition to the next step.

When the DP control unit 120 receives the completion notification from the control device 300 (step S7/YES), the DP control unit 120 transmits a reception notification notifying the control device 300 that the completion notification has been received (step S8), and terminates this processing flow.

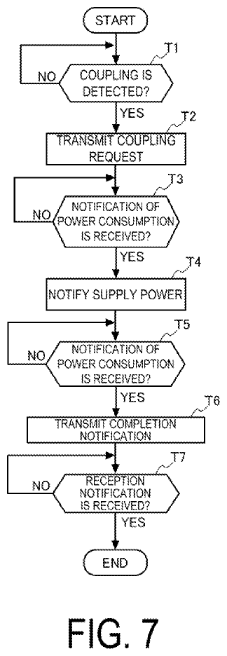

FIG. 7 is a flowchart illustrating the operation of the control device 300 in the negotiation.

The CO control unit 310 determines whether coupling is detected (step T1).

The CO control unit 310 detects that the control device 300 is coupled to the I/F unit 331 (step T1). Similar to the HMD 100, the CO control unit 310 detects the coupling by detecting the VBUS by a voltage monitoring unit (not illustrated) provided at the I/F unit 331. When no coupling is detected (step T1/NO), the CO control unit 310 does not perform the processing step T2 and subsequent steps.

When the coupling is detected (step T1/YES), the CO control unit 310 transmits a coupling request to the HMD 100 to which the coupling is established (step T2).

Next, the CO control unit 310 determines whether a notification of power consumption has been received from the HMD 100 (step T3). When the CO control unit 310 has not received the notification of the power consumption from the HMD 100 (step T3/NO), the CO control unit 310 does not transition to step T4.

When the CO control unit 310 receives the notification of the power consumption from the HMD 100 (step T3), the CO control unit 310 notifies the HMD 100 of the supply power, which is the power that the control device 300 can supply to the HMD 100 (step T4).

Next, the CO control unit 310 determines whether the notification of the power consumption has been received from the HMD 100 (step T5). When the CO control unit 310 has not received the notification of the power consumption from the HMD 100 (step T5/NO), the CO control unit 310 does not transition to the process in step T6.

When the CO control unit 310 receives the notification of the power consumption from the HMD 100 (step T5/YES), the CO control unit 310 transmits a completion notification to the HMD 100 (step T6). Thereafter, the CO control unit 310 determines whether a reception notification is received from the HMD 100 (step T7). When the CO control unit 310 has not received the reception notification (step T7/NO), the CO control unit 310 waits until a reception notification is received.

When the CO control unit 310 receives the completion notification from the HMD 100 (step T7/YES), the CO control unit 310 terminates the negotiation and starts supplying power to the HMD 100.

Next, the operation after the negotiation will be described.

When the DP control unit 120 receives operation of newly activating the function unit after the negotiation has been completed, the DP control unit 120 determines whether the function unit selected by this operation can be activated. For example, the DP control unit 120 determines whether the selected function unit can be operated by changing the operating mode of the HMD 100 to an operating mode with lower power consumption than that in an operating mode determined when negotiation. The changes of the operating mode include selection of a function unit to stop operation, changing operating parameters, etc. Changing the operating parameters means changing the power consumption of the function unit to operating parameters that can further reduce the power consumption.

The DP control unit 120 determines whether the selected function unit can be activated based on the power consumption in each operating mode, the supply power supplied from the control device 300, and the power consumption of the selected function unit. For example, the DP control unit 120 determines that the selected function unit can be activated when the sum of the power consumed by the newly activated function unit and the power consumption in the changed operating mode is less than or equal to the power consumption of the current operating mode prior to newly activating the function unit.

In addition, in a case where the DP control unit 120 cannot activate a new function unit in the change of the operating mode, the DP control unit 120 determines whether the new function unit can be activated by stopping other function units during operation. The other function units that stop operation may be one unit or a plurality of units. The DP control unit 120 selects the other function unit that is operational and can stop operation thereof. The DP control unit 120 compares the power consumed by the selected other function unit with the power consumption of the newly activated function unit to determine whether the new function unit can be activated. The DP control unit 120 stops the operation of the selected other function unit and activates the newly activated function unit, when the DP control unit 120 determines that the power consumption of the selected other function unit is greater than the power consumption of the newly activated function unit and it is possible to activate the newly activated function unit, Additionally, the DP control unit 120 may determine whether there is a function unit that can be further stopped when the power consumed by the newly activated function unit is greater than the power consumption of the other function unit.

The DP control unit 120 may determine whether the new function unit can be activated by changing the operation of the other function unit during operation to low power consumption operation.

When the power consumption of the other function unit during operation is greater than the power consumption of the newly activated function unit, the DP control unit 120 determines that the function unit can be newly activated by stopping operation of the function unit during the operation. In this case, the DP control unit 120 transmits the information of other function unit that is a candidate for stopping the operation thereof to the control device 300.

When the CO control unit 310 receives the information of the other function unit that is a candidate for stopping the operation thereof from the HMD 100, the CO control unit 310 causes the CO display unit 327 to display information of the received other function unit. Furthermore, the CO control unit 310 causes the CO display unit 327 to display a guide inquiring whether the operation of the other function unit may be stopped.

When the CO control unit 310 receives operation allowing the operation of the touch panel 328 to stop the operation of the other function unit, the CO control unit 310 transmits an authorization notification to the HMD 100 that allows the operation to be stopped.

When the DP control unit 120 receives a notification that allows the control device 300 to stop the operation of the other function unit, the DP control unit 120 stops the operation of the other function unit and activates the selected function unit.

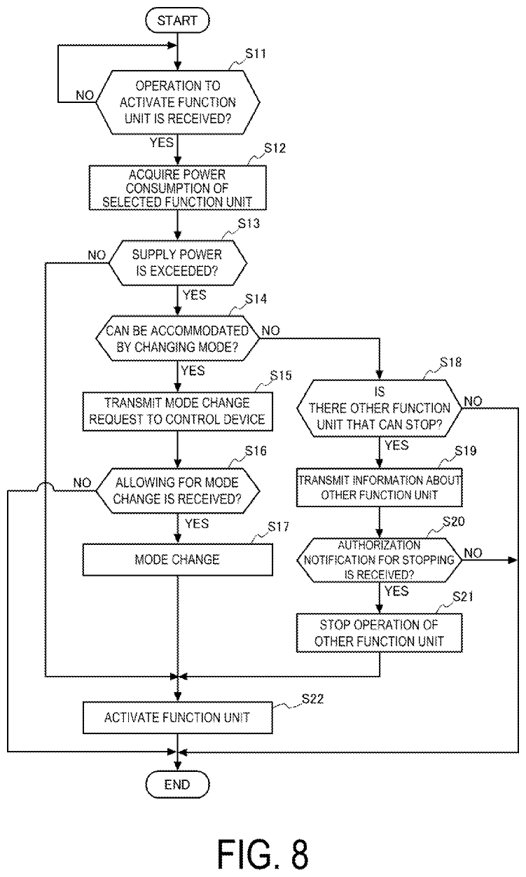

FIG. 8 is a flowchart illustrating the operation of the DP control unit 120 in a case where the operation of activating the function unit mounted on the HMD 100 has been received.

First, the DP control unit 120 determines whether operation to activate the function unit has been received (step S11). When the DP control unit 120 does not receive an operation for activating the function unit (step S11/NO), the DP control unit 120 does not transition to the determination in step S12 until an operation for activating the function unit is received.

When the DP control unit 120 receives the operation to activate the function unit (step S11/YES), the DP control unit 120 refers to the power consumption table 135 illustrated in FIG. 5 to acquire the power consumption when operating the function unit selected by the operation (step S12).

The DP control unit 120 determines whether the total power obtained by adding the power consumption of the selected function unit to the power consumption of the current operating mode of the HMD 100 exceeds the power supply of the control device 300 (step S13). When the total power does not exceed the supply power (step S13/NO), the DP control unit 120 activates the selected function unit (step S22).

When the total power exceeds the supply power (step S13/YES), the DP control unit 120 determines whether the total power can be held down to or below the supply power by changing the operating mode of the HMD 100 to other modes (step S14).

When the DP control unit 120 determines that the total power can be held down to or below the supply power by changing the operating mode (step S14/YES), the DP control unit 120 transmits a change request for the operating mode of the HMD 100 to the control device 300 (step S15).

Next, the DP control unit 120 determines whether the notification allowing the change in operating mode has been received from the control device 300 (step S16).

When no change in operating mode is allowed (step S16/NO), the DP control unit 120 does not change the operating mode, and terminates the flow without activating the selected function unit.

When the DP control unit 120 is allowed to change the operating mode (step S16/YES), the DP control unit 120 causes the operating mode to transition to an operating mode in which it is determined in step S14 that the total power is less than or equal to the supply power (step S17). Thereafter, the DP control unit 120 activates the selected function unit (step S22).

Additionally, when the DP control unit 120 determines that the DP control unit 120 cannot cope with by change of the operating mode (step S14/NO), the DP control unit 120 determines whether there are other function units where the operation can be stopped and the total power becomes less than or equal to the supply power by stopping the operation (step S18). When there is no other function unit (step S18/NO), the DP control unit 120 terminates the processing flow without activating the selected function unit.

In addition, when there is the other function unit (steps S18/YES), the DP control unit 120 transmits information of the other function unit that can stop this operation to the control device 300 (step S19). Thereafter, when the DP control unit 120 receives, from the control device 300, a rejection notification that rejects the stop of the operation of the other function unit (step S20/NO), the DP control unit 120 terminates this flow without stopping the operation of the other function unit.

In addition, when the DP control unit 120 receives, from the control device 300, the authorization notification allowing the stop of the operation of the other function unit (step S20/YES), the DP control unit 120 stops the operation of the other function unit (step S21) and activates the selected function unit (step S22).

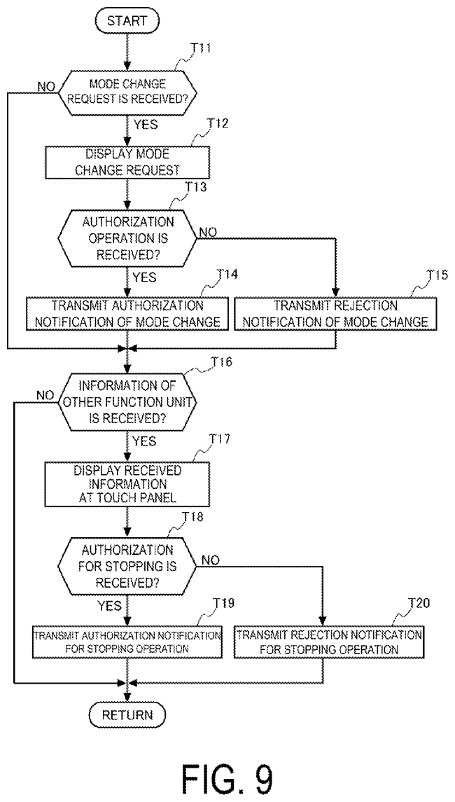

FIG. 9 is a flowchart illustrating the operation of the control device 300.

The CO control unit 310 determines whether a change request for the operating mode has been received from the HMD 100 (step T11). When the CO control unit 310 has not received the change request for the operating mode from the HMD 100 (step T11/NO), the CO control unit 310 proceeds to the determination of step T16.

When the CO control unit 310 receives the change request for the operating mode from the HMD 100 (step T11/YES), the CO control unit 310 causes the CO display unit 327 to display the change request for the operating mode of the HMD 100 (step T12). When the CO control unit 310 has received operation allowing changes in the operating mode of the HMD 100 (step T13/YES), the CO control unit 310 transmits the HMD 100 the authorization notification allowing changes in the operating mode (step T14). In addition, when the CO control unit 310 has received operation that rejects changes in the operating mode of the HMD 100 (step T13/NO), the CO control unit 310 notifies the HMD 100 of the rejection notification that rejects changes in the operating mode (step T15).

Next, the CO control unit 310 determines whether information of the other function unit that stops operation is received from the HMD 100 (step T16). When the CO control unit 310 has not received the information of the other function unit (step T16/NO), the CO control unit 310 returns to the determination of step T11.

In addition, when the CO control unit 310 receives, from the HMD 100, information of the other function unit that stops operation (step T16/YES), the CO control unit 310 causes the touch panel 328 to display the information of the other function unit received from the HMD 100 and a guide confirming whether the operation of the other function unit may be stopped (step T17). Next, the CO control unit 310 determines whether operation is received that allows the operation of the other function unit to be stopped (step T18). When the CO control unit 310 receives operation allowing the operation of the other function unit to be stopped (step T18/YES), the CO control unit 310 transmits the authorization notification to the HMD 100 that allows the operation of the other function unit to be stopped (step T19). In addition, when the CO control unit 310 has received operation to reject to stop the operation of the other function unit (step T18/NO), the CO control unit 310 transmits the rejection notification to the HMD 100 that rejects the stop of the operation of the other function unit (step T20).

As described above, the display system 1 includes the HMD 100 that displays an image and the control device 300 to which the HMD 100 is coupled.

The control device 300 includes the first supply unit and a first output unit.

The first supply unit is constituted by the battery 329 that supplies power to the HMD 100.

The first output unit is constituted by the I/F unit 331 that outputs a playback signal including at least one of an image and a sound.

The HMD 100 includes the image display unit 20, the sound output unit, the detection unit, and a second supply unit.

The image display unit 20 displays an image included in the playback signal received from the control device 300.

The sound output unit is constituted by the sound processing unit 147, the right earphone 32, and the left earphone 34, and outputs a sound included in the playback signal.

The detection unit is constituted by a sensor group. The sensor group includes the DP outer camera 61, the distance sensor 64, the DP illuminance sensor 65, the temperature sensor 217, the DP six-axis sensor 235, the DP magnetic sensor 237 and the temperature sensor 239.

Additionally, the HMD 100 includes the power control unit 126 that supplies power supplied from the control device 300 to the supply destination, and the power supply unit 229, 249.

The display system 1 stops part of operation of the display unit, the sound output unit, and the detection unit when the power consumed by the HMD 100 is greater than the power supplied by the control device 300. Additionally, the HMD 100 operates the image display unit 20, the sound output unit, and the detection unit so that the power consumed by the HMD 100 is smaller than the power supplied from the control device 300.

Accordingly, even when the power supplied from the control device 300 is smaller than the power consumed by the HMD 100, the power consumed by the HMD 100 can be reduced and the HMD 100 can be operated with the power supplied from the control device 300.

The image display unit 20 includes the right display unit 22 as the first display unit and the left display unit 24 as the second display unit.

When the power supplied by the control device 300 is smaller than the power consumed by the HMD 100, the display system 1 does not display an image on at least one of the right display unit 22 and the left display unit 24.

Accordingly, even when the power supplied from the control device 300 is smaller than the power consumed by the HMD 100, the power consumed by the HMD 100 can be reduced by making the display unit that displays the image to be at least one of the right display unit 22 and the left display unit 24. Thus, the HMD 100 can be operated with the power supplied from the control device 300.

The display system 1 stops at least one operation of the plurality of sensors when the power supplied by the control device 300 is smaller than the power consumed by the HMD 100.

The display system 1 also reduces at least one sampling frequency of the plurality of sensors as compared with a case where the power supplied by the control device 300 is greater than the power consumed by the HMD 100.

Accordingly, the power consumed by the HMD 100 can be reduced and the HMD 100 can be operated with the power supplied from the control device 300.

The sensor group includes the DP outer camera 61.

When the power supplied by the control device 300 is smaller than the power consumed by the HMD 100, the display system 1 reduces at least one of the imaging resolution of the DP outer camera 61 and the number of times of imaging per unit time as compared with a case where the power supplied by the control device 300 is greater than the power consumed by the HMD 100.

Accordingly, the power consumed by the HMD 100 can be reduced and the HMD 100 can be operated with the power supplied from the control device 300.

In addition, when the power supplied by the control device 300 is smaller than the power consumed by the HMD 100, the display system 1 stops outputting a sound to the sound output unit. The display system 1 also reduces the sound output from the sound output unit as compared with a case where the power supplied by the control device 300 is greater than the power consumed by the HMD 100.

Accordingly, the power consumed by the HMD 100 can be reduced and the HMD 100 can be operated with the power supplied from the control device 300.

Further, when the power supplied by the control device 300 is smaller than the power consumed by the HMD 100, the display system 1 reduces at least one of the refresh rate of the image display unit 20 and the brightness of the display unit as compared with a case where the power supplied by the control device 300 is greater than the power consumed by the HMD 100.

Accordingly, the power consumed by the HMD 100 can be reduced and the HMD 100 can be operated with the power supplied from the control device 300.

The present disclosure is not limited to the configuration described in each of the above exemplary embodiments, and can be implemented in various aspects without departing from the gist thereof.

For example, in the exemplary embodiments described above, a case in which the DP control unit 120 of the HMD 100 determines the power supply destination has been described. Otherwise, the CO control unit 310 of the control device 300 may select a function unit to stop operation or limit functionality based on the power consumed by the HMD 100 and the power that can be supplied by the control device 300.

In addition, while the display system 1 is illustrated with the HMD 100 serving as a head-mounted display apparatus, the present disclosure is not limited thereto, and various types of display devices can be employed. For example, instead of the image display unit 20, for example, another type of image display unit such as an image display unit to be worn like a cap, for example, may be employed. Such an image display unit may include a display unit configured to display images corresponding to the left eye LE of the user U and a display unit configured to display images corresponding to the right eye RE of the user U. Additionally, the display device in the present disclosure may be configured, for example, as a head-mounted display mounted on a vehicle such as a car, and an airplane. Further, the display device may be configured, for example, as a head-mounted display built into a body protector tool such as a helmet. In such a case, a portion for positioning the device with respect to the body of the user U, and a portion positioned with respect to the portion described earlier can be a mounting section.

The HMD 100 is an example of a display device to be applied to the present disclosure, and is not limited to the configuration illustrated in FIG. 3. For example, in the above exemplary embodiment, the configuration in which the image display unit 20 and the coupling device 10 are separated has been described as an example, however, it is also possible that the coupling device 10 and the image display unit 20 are integrally configured and mounted on the head of the user U. Further, the configuration of the optical system of the image display unit 20 is optional, and for example, an optical member positioned in front of the eye of the user U and overlapping some or all of the field of view of the user U may be used. Alternatively, a scanning optical system that scans laser light etc. to obtain imaging light may be adopted. Alternatively, without being limited to a configuration that light-guides the imaging light inside the optical member, the configuration may only have a function of refracting and/or reflecting the imaging light toward the eye of the user U.

The display device may employ a liquid crystal monitor or a liquid crystal television that displays an image on the liquid crystal display panel. A display device including a plasma display panel and an organic EL display panel may be used. In this case, the display panel corresponds to the display unit of the present disclosure. A projector that projects the imaging light onto a screen, etc. may be used as the display device.

For example, in the HMD 100 illustrated in FIG. 3, the coupling device 10 may be configured using the USB-Type C connector, the USB-Type C controller, and a USB hub. In this case, the DP outer camera 61 and other sensors may be coupled to the USB hub. Further, as a controller for controlling display of the right display unit 22 and the left display unit 24 in the image display unit 20, the FPGA that outputs the display data to the right display unit 22 and the left display unit 24 may be arranged in either the right display unit 22 or the left display unit 24. In this case, the coupling device 10 may include a bridge controller that the USB-Type C controller and the FPGA. Additionally, the image display unit 20 may have a configuration in which the DP six-axis sensor 235, the DP magnetic sensor 237, the EEPROM 215, etc. are mounted on the same substrate as the FPGA. The arrangement of the other sensors can also be modified accordingly. For example, the distance sensor 64 and the DP illuminance sensor 65 may be arranged at positions suitable for measurement or detection, and may be coupled to the FPGA or the USB-Type C controller.

There is no particular limitation on the specific specifications of the display device including the OLED units 221, 241, for example, the OLED units 221, 241 may have a common configuration.

At least some of the functional blocks illustrated in FIGS. 3 and 4 may be achieved in the form of hardware or may be achieved by a cooperation of hardware and software, and, is not limited to a configuration in which independent hardware resources are arranged as illustrated in the drawings.

Further, the flowchart illustrating the processing of the HMD 100 illustrated in FIGS. 6 and 8 is divided according to the main processing contents in order to make the processing of the DP control unit 120 easy to understand. The present disclosure is not limited by the manner and name of division of the processing unit illustrated in the flowcharts of FIGS. 6 and 8. The processing of the DP control unit 120 can be divided into more processing units in accordance with a processing content, and can be divided such that one processing unit includes more processing. An order of the processing in the above-described flowchart is also not limited to the illustrated example.

Further, the flowchart illustrating the processing of the control device 300 illustrated in FIGS. 7 and 9 is divided according to the main processing contents in order to make the processing of the CO control unit 310 easy to understand. The present disclosure is not limited by the manner and name of division of the processing unit illustrated in the flowcharts of FIGS. 7 and 9. The processing of the CO control unit 310 can be divided into more processing units in accordance with a processing content, and can be divided such that one processing unit includes more processing. An order of the processing in the above-described flowchart is also not limited to the illustrated example.

In a case where the computer provided by the HMD 100 is used to implement the control method for the display device, the program executed on the computer can be configured in the form of a recording medium or a transmission medium transmitting the program. As the recording medium, a magnetic or optical recording medium or a semiconductor memory function unit can be used. The recording medium described above may be non-volatile storage devices such as a RAM, a ROM, and an HDD, which is an internal storage device included in the server device.

What is claimed is:

1. A display system comprising:
an information processing device that includes:
a supply unit that supplies a first power; and
an output unit that outputs a playback signal including an image and a sound; and
a display device that includes:
a display unit that displays the image;
a sound output unit that outputs the sound;
a first sensor; and
a supply unit that supplies the first power to the display unit, the sound output unit, and the first sensor, wherein
when a second power consumed by the display device is greater than the first power, part of operation of the display unit, the sound output unit, and the detection unit is stopped or the display unit, the sound output unit, and the detection unit are operated so that the second power is smaller than the first power.

2. A display system comprising:
an information processing device that includes:
a supply unit that supplies a first power; and
an output unit that outputs a playback signal including an image; and
a display device that includes:
a first display unit that displays the image;
a second display unit that display the image and that is different from the first display unit; and
a supply unit that supplies the first power to the first display unit and the second display unit, wherein
when a second power consumed by the display device is greater than the first power, at least one of the first display unit and the second display unit does not display the image.

3. The display system according to claim 1, comprising a second sensor different from the first sensor, wherein
when the second power is greater than the first power, operation of at least one of the first sensor and the second sensor is stopped or a sampling frequency of at least one of the first sensor and the second sensor is less than the sampling frequency in a case where the first power is greater than the second power.

4. The display system according to claim 1, wherein
the first sensor is a camera, and
when the second power is greater than the first power, at least one of an imaging resolution of the camera and a number of times of imaging per unit time is less than the at least one of the imaging resolution of the camera and the number of times of imaging per unit time in a case where the first power is greater than the second power.

5. The display system according to claim 1, wherein
when the second power is greater than the first power, the sound output unit stops outputting the sound or the sound output unit reduces the sound output to less than the sound output in a case where the first power is greater than the second power.

6. The display system according to claim 1, wherein
when the second power is greater than the first power, at least one of a refresh rate of the display unit and a brightness of the display unit is less than the at least one of the refresh rate of the display unit and the brightness of the display unit in a case where the first power is greater than the second power.

7. A display device comprising:
a sensor;
a display unit that displays an image;
a sound output unit that outputs a sound;
a supply unit that supplies a first power to the display unit, the sound output unit, and the sensor; and
a control unit that controls the supply unit so that a second power consumed by the display unit, the sound output unit, and the sensor is less than or equal to the first power.
